(19) United States
(12) Patent Application Publication
(10) Pub. No.: US 2007/0119931 A1
(43) Pub. Date: May 31, 2007

(54) Apparatus for reading/writing storage devices

(75) Inventors: Yu-Hung Liu, Tiu-Liu City (TW); Yi-Chen Ho, Taipei (TW); Yi-Chin Huang, Taipei (TW); Hsiang-Hua Chao, Taipei (TW); Yu-Shen Liu, Taichung (TW)

Correspondence Address: BIRCH STEWART KOLASCH & BIRCH, PO BOX 747, FALLS CHURCH, VA, 22040-0747, US

(73) Assignee: C-Media Electronics Inc., Taipei (TW)

(21) Appl. No.: 11/286,408

(22) Filed: Nov. 25, 2005

(51) Int. Cl. G06K 7/06

(52) U.S. Cl. 235/441

(57) ABSTRACT

The conventional apparatus for reading/writing storage devices need a built-in microprocessor control unit (MCU) to process commands. Thus, the flexiability (e.g.: supporting capacity of storage device) and the cost of the apparatus are not satisfied. The present invention employs a driver and a hardwire circuit to replace the MCU for money saving without changing other units in the apparatus. Moreover, the apparatus of the present invention can raise the supporting capacity of storage device and compatibility by just updating the driver.

### FIELD OF THE INVENTION

The preset invention relates to apparatus for reading/writing storage devices, more particularly relates to apparatus without built-in MCU (microprocessor control unit) for reading/writing storage devices.

### BACKGROUND OF THE INVENTION

Most of traditional memory card I/O (Input/Output) devices for example, the card reader are incorporated with a built-in MCU (microprocessor control unit) for processing the memory card instructions from PCs (personal computers.) Referring to FIG. 1, it illustrates the function diagram according to the prior art, which illustrates the connection among a traditional memory card I/O device 10, a memory card 60 and a PC. Taking writing data to the memory card 60 as an example, procedures between the traditional memory card I/O device 10 and the PC include the sequence of transferring SCSI (Small Computer System Interface) instructions and data from the PC to the USB (Universal Serial Bus) interface 30 through the South Bridge incorporated in the PC. The USB interface 30 translates the SCSI instructions into the USB packets followed by sending the translated data out. After the MCU 40 decodes the USB packets to the memory card instructions and the data, the MCU further deliveries the memory card instructions and the data to the memory card interface 50. Finally, the memory card interface 50 writes the data to the memory card 60 according to the memory card instructions.

The MCU has basic microinstructions, and the driver of the traditional memory card I/O device calls the microinstructions in order to handle the communications between the PCs and the memory cards. Main function of the MCU is an interpreter for the USB instructions and the memory card instructions, and the MCU also provides functions for the memory card without built-in MCU (such as a smart media card, an eXtreme Digital card and a memory stick card) to build up a PTL (physical to logical translation table) table and support lager capacities.

Generally, the MCU includes an EEPROM (Electrically Erasable & Programmable ROM) for storing the microinstructions. Typically, the users have to upgrade the firmware in order to recover certain problem when the capability of memory card fails to meet the requirement. In order to upgrade the firmware, the users have to connect their memory card I/O devices to the PC by USB connector. However, the failure risk of the updating process is extremely high. On the other hands, the manufacturers usually suggest the customs not to do so, and the solution of the problem becomes highly difficult.

In accordance with aforementioned situations, the cost of the traditional solution for the memory card I/O devices is too high and the flexibility of the traditional memory card I/O device is also not enough. What is required is a novel scheme to solve the problem.

### SUMMARY OF THE INVENTION

Above-mentioned theological arts are well know to those skilled in the art, and the cost of the memory card I/O device is too high, the flexibility is relatively too low. One purpose of the present invention is to reduce the cost of the memory card I/O device by providing an apparatus without MCU (microprocessor control unit) for reading/writing storage devices.

Another purpose of the present invention is to increase the flexibility of the memory card I/O device in ways of providing an apparatus, whose capacity and supportability can be modified by updating relative driver, for reading/writing storage devices.

Based on foregoing purposes, the present invention discloses an apparatus for reading/writing memory cards. The apparatus includes a transfer interface, a finite state machine, a control register and a memory card control interface. The transfer interface outputs detailed commands and data received from a host, and receives the data and status signals of a memory card; the control register temporarily stores and outputs the detailed commands, the data of the memory card and the status signals of the memory card; the finite state machine receives the detailed commands, and outputs processing steps based on the detailed commands and the status signals of the memory card; the memory card control interface receives the processing steps and delivers memory card control commands based on the processing steps, furthermore, the memory card control interface also sends the status signals of the memory card based on a status of the memory card, transfers the data to the memory card, and receives the data of the memory card from the memory card and transfers the data of the memory card to the control register simultaneously.

The present invention also discloses an apparatus for reading/writing storage elements. The aforementioned apparatus includes a transfer interface, a hardwired circuit and a storage element control device. The transfer interface transfers detailed commands and data; and the hardwired circuit that is coupled to the transfer interface, transfers the data and outputs processing steps based on the detailed commands; and the storage device control device that is coupled to the hardwired circuit, transfers storage device commands to a storage device in accordance with the processing steps.

The present invention further discloses a hardwired circuit for apparatus of reading/writing storage devices, includes a control register for temporarily storing detailed commands and data; and a finite state machine for receiving the detailed commands, and outputting processing steps based on the detailed commands; wherein the detailed commands are compiled from SCSI instructions by a driver of a host.

### BRIEF DESCRIPTION OF THE DRAWINGS

FIG. 1 is a block diagram, which illustrates a traditional memory card I/O device.

FIG. 2 is a block diagram, which illustrates a preferred embodiment of the present invention.

FIG. 3 is a block diagram, which illustrates another preferred embodiment of the present invention.

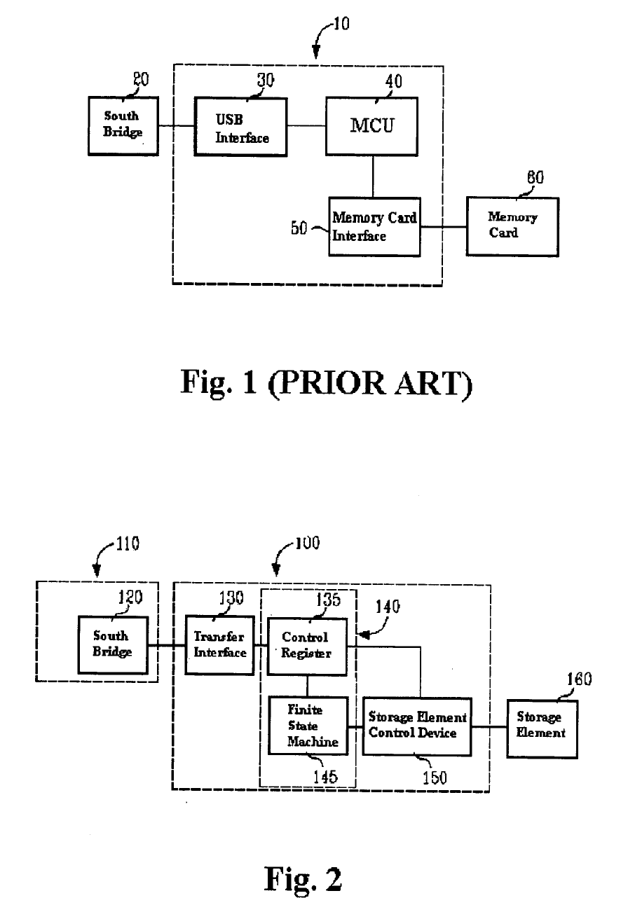

### DETAILED DESCRIPTION OF THE PREFERRED EMBODIMENT

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

The essence of the present invention is to replace the built-in MCU (microprocessor control unit) inside traditional memory card I/O devices by software and a hardwired circuit. The tasks which previously were processed by the MCU, like supporting the memory capacity and building up the PTL (physical to logical translation table) table, will be taken by the software. At the meantime, the SCSI (Small Computer System Interface) instructions, which are sent from the OS (operation system) to the memory card I/O device, will also be processed by the software, and the software will further compile the SCSI into detailed commands. Subsequently, the hardwired circuit will process the detailed commands, and translate the detailed commands into memory commands. In this manner, whole functions of the MCU are fully replaced by the hardwired circuit and the software, thereby extremely reducing the cost of the memory card reading/writing devices by omitting the MCU from the memory card I/O devices. Furthermore, the problems of upgrading the firmware in the traditional memory card I/O devices can be simply solved by updating the driver software in the present invention.

Referring to FIG. 2 illustrates one of the preferred embodiments of the present invention. The storage elements reading/writing device 100 includes a transfer interface 130, a hardwired circuit 140 and a storage element control device 150. The transfer interface 130 coupled to a South Bridge chip 120 of a host 100 (for example, a notebook, laptop PC or a PC, personal computer, Desktop computer,) transfers detailed commands and data for subsequent process; the hardwired circuit 140 that is coupled to the transfer interface 130, transfers the data and outputs processing steps based on the detailed commands. The storage element control device 150 coupled to the hardwired circuit 140 transfers storage device commands to a storage device 160 in accordance with the processing steps.

The hardwired circuit 140 further includes a control register 135 and a finite state machine 145. The control register 135 temporarily stores the detailed commands and the data from the transfer interface 130, and separately sends the detailed commands to the finite state machine 145 and the data to the storage element control device 150. After receiving the detailed commands, the finite state machine 145 outputs processing steps based on the detailed commands to the storage element control device 150. The storage element control device 150 receives the processing steps and subsequently deliveries the storage element commands based on the received processing steps to the storage element 160, and also sends status signals of the storage element, which are based on the status of the storage element 160, to the finite state machine 145, thereby allowing the finite state machine 145 can arrange the processing steps in accordance with the status of the storage element 160.

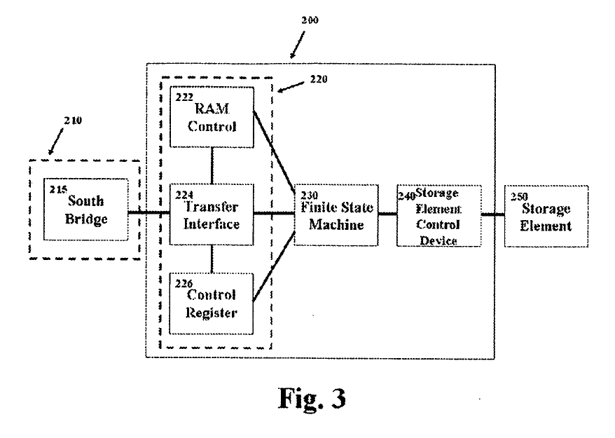

Referring to FIG. 3 illustrates another preferred embodiment of the present invention. The storage element reading/writing device 200 includes a transfer layer 220, a finite state machine 230 and a storage element control device 240. In respect of accompanying drawing, the transfer layer 220 that is coupled to a South Bridge chip 215 of a host 210 (for example, a notebook, laptop PC or a PC, personal computer, Desktop computer,) transfers detailed commands and data. The finite state machine 230 coupled to the transfer layer 220 transfers the data and outputs processing steps based on the received detailed commands and the storage device control device 240 coupled to the finite state machine 230 is used to transfer storage device commands to a storage device 250 in accordance with the processing steps. Besides, the transfer layer 220 further includes a RAM control 222, a transfer interface 224 and a control register 226.

Above-mentioned detailed commands are compiled from SCSI instructions by a driver of the host 110 or 210. The detailed commands include Read, Write, Erase, Copy, Scan Extra Area, Reset Card, Format Card and the combinations thereof. The foregoing data includes writing data from the host 110 or 210 to the storage device 160 or 250, reading data from the storage device 160 or 250 to the host 110 or 210.

The antecedent transfer interface 130 can be a FIFO interface, however, the transfer interface 130 or 224 also can be USB (Universal Serial Bus) interface or IEEE1394 (FireWire) interface. It means that the storage element reading/writing device 100 or 200 is coupled to the host 110 or 210 through the USB port or the IEEE1394 port. The storage elements of the present invention include following two different types; one is a flash memory card with built-in MCU, another is a flash memory card without built-in MCU. The flash memory card with built-in MCU includes a compact flash card, a micro drive, a secure digital card, a memory stick pro card and a multimedia card; and the flash memory card without built-in MCU further includes a smart media card, an eXtreme Digital card and a memory stick card. Furthermore, the storage elements also include the storage elements with built-in MCU, for example a compact flash card, a micro drive, a secure digital card, a memory stick pro card and a multimedia card; and the storage elements without built-in MCU, for example a smart media card, an eXtreme Digital card and a memory stick card. With regard to other embodiment, the storage elements even include a smart card (IC card.)

Moreover, the storage element reading/writing device 100 or 200 in present invention can even have plural slots which are coupled to storage element control interface 150 or 240. The plural slots include a smart card slot, a compact flash card slot, a micro drive slot, a secure digital card slot, a memory stick pro card slot, a multimedia card slot, a smart media card slot, an eXtreme Digital card slot, a memory stick card slot and the combinations thereof.

In terms of former illustration, the storage element reading/writing device of the present invention may omit the built-in MCU, so as to significantly reduce the cost of making the storage element reading/writing device. In addition, by the practice of updating the driver, the present invention can be better than the conventional manner of upgrading the firmware, and not only reduces the risk of failure upgrading firmware but also improves the flexibility of the storage element reading/writing device structure. The conventional storage element reading/writing devices usually have compatibility troubles of the storage elements by various vendors, yet the compatibilities of the storage elements in the present invention can easily be enhanced by adjusting the timing of the relative driver.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

We claim:

1. An apparatus for reading/writing memory cards comprising:
a transfer interface for outputting detailed commands and data received from a host, and for receiving said data and status signals of a memory card;
a control register coupled to said transfer interface for temporarily storing and outputting said detailed commands, said data of said memory card and said status signals of said memory card;
a finite state machine coupled to said control register for receiving said detailed commands, and outputting processing steps based on said detailed commands and said status signals of said memory card; and
a memory card control interface coupled to said finite state machine for receiving said processing steps, and outputting memory card control commands based on said processing steps.

2. The apparatus of claim 1, wherein said detailed commands are compiled from SCSI (Small Computer System Interface) instructions by a driver of said host.

3. The apparatus of claim 2, wherein said transfer interface is a FIFO (First In First Out) interface.

4. The apparatus of claim 3, wherein said apparatus for reading/writing memory cards is coupled to said host by a USB (Universal Serial Bus) port or an IEEE1394 (FireWire) port.

5. The apparatus of claim 2, wherein said memory card comprises a flash memory card with built-in MCU (microprocessor control unit.)

6. The apparatus of claim 5, wherein said flash memory card with built-in MCU comprises a compact flash card, a micro drive, a secure digital card, a memory stick pro card and a multimedia card.

7. The apparatus of claim 2, wherein said memory card comprises a flash memory card without built-in MCU (microprocessor control unit.)

8. The apparatus of claim 7, wherein said flash memory card without built-in MCU comprises a smart media card, an eXtreme Digital card and a memory stick card.

9. The apparatus of claim 2, wherein said detailed commands comprises Read, Write, Erase, Copy, Scan Extra Area, Reset Card, Format Card and combinations thereof.

10. The apparatus of claim 2, further comprising plural slots which are coupled to said memory card control interface.

11. The apparatus of claim 10, wherein said plural slots comprise a compact flash card slot, a micro drive slot, a secure digital card slot, a memory stick pro card slot, a multimedia card slot, a smart media card slot, an eXtreme Digital card slot, a memory stick card slot and combinations thereof.

12. The apparatus of claim 2, further comprising a register coupled to said finite state machine.

13. An apparatus for reading/writing storage devices comprising:
a transfer layer for transferring detailed commands and data;
a hardwired circuit that is coupled to said transfer interface for transferring said data and outputting processing steps based on said detailed commands; and
a storage device control device that is coupled to said hardwired circuit for transferring storage device commands to a storage device in accordance with said processing steps.

14. The apparatus of claim 13, wherein said detailed commands are compiled from SCSI instructions by a driver of a host.

15. The apparatus of claim 14, wherein said data comprise writing data from said host to said storage device and reading data from said storage device to said host.

16. The apparatus of claim 14, wherein said transfer layer is a FIFO interface.

17. The apparatus of claim 16, wherein said apparatus for reading/writing storage devices is coupled to said host by a USB port or an IEEE1394 port.

18. The apparatus of claim 14, wherein said storage device comprises a storage device with built-in MCU.

19. The apparatus of claim 18, wherein said storage device with built-in MCU comprises a compact flash card, a micro drive, a secure digital card, a memory stick pro card and a multimedia card.

20. The apparatus of claim 19, wherein said storage device with built-in MCU further comprises a smart card.

21. The apparatus of claim 14, wherein said storage device comprises a storage device without built-in MCU.

22. The apparatus of claim 21, wherein said storage device without built-in MCU comprises a smart media card, an eXtreme Digital card and a memory stick card.

23. The apparatus of claim 14, wherein said detailed commands comprises Read, Write, Erase, Copy, Scan Extra Area, Reset Card, Format Card and combinations thereof.

24. The apparatus of claim 14, further comprising plural slots which are coupled to said storage device control interface.

25. The apparatus of claim 24, wherein said plural slots comprise a compact flash card slot, a micro drive slot, a secure digital card slot, a memory stick pro card slot, a multimedia card slot, a smart media card slot, an eXtreme Digital card slot, a memory stick card slot and combinations thereof.

26. The apparatus of claim 25, wherein said plural slots further comprise a smart card slot.

27. A hardwired circuit for apparatus of reading/writing storage devices, comprising:
a control register for temporarily storing detailed commands and data; and
a finite state machine for receiving said detailed commands, and outputting processing steps based on said detailed commands;
wherein said detailed commands are compiled from SCSI instructions by a driver of a host.

28. The hardwired circuit of claim 26, wherein said detailed commands comprises Read, Write, Erase, Copy, Scan Extra Area, Reset Card, Format Card and combinations thereof.

29. The hardwired circuit of claim 26, wherein said storage devices comprise a storage device with built-in MCU.

30. The hardwired circuit of claim 28, wherein said storage device with built-in MCU comprises a compact flash card, a micro drive, a secure digital card, a memory stick pro card and a multimedia card.

31. The hardwired circuit of claim 29, wherein said storage device with built-in MCU further comprises a smart card.

32. The hardwired circuit of claim 26, wherein said storage devices comprise a storage device without built-in MCU.

33. The hardwired circuit of claim 31, wherein said storage device without built-in MCU comprises a smart media card, an eXtreme Digital card and a memory stick card.
